(19) United States
(12) Patent Application Publication
(10) Pub. No.: US 2009/0024316 A1
(43) Pub. Date: Jan. 22, 2009

(54) METHOD AND SYSTEM USING SMS NOTIFICATION AND AN INTERNET BROWSER TO PROVIDE REALTIME TRANSPORT INFORMATION

(75) Inventor: Jonathan Adhi Sutanto, New South Wales (AU)

Correspondence Address: BROOKS KUSHMAN P.C., 1000 TOWN CENTER, TWENTY-SECOND FLOOR, SOUTHFIELD, MI, 48075, US

(73) Assignee: NAVCITY PTY LTD, Bowral, NSW (AU)

(21) Appl. No.: 11/571,767

(22) PCT Filed: Jul. 8, 2004
(86) PCT No.: PCT/AU04/00921

§ 371 Date: Jan. 8, 2007

(51) Int. Cl. G01C 21/34

(52) U.S. Cl. 701/209

(57) ABSTRACT

A method of tracking travel plans, the method comprising the steps of: (a) forming a current travel plan on an internet interactive database; (b) initially forwarding a coded indicator of the current travel plan on a mobile communications device; (c) utilising the coded indicator to interrogate a remote database of current travel information to determine travel logistic information relevant to the current travel plan; (d) communicating issues associated with the logistics of the current travel plan with the mobile communications device; (e) conveying the issues to a user of the mobile communications device.

### FIELD OF THE INVENTION

This invention relates to transport information systems and methods, generally. In particular, this invention provides a system and method for supplying real-time transport information via a mobile device.

### BACKGROUND OF THE INVENTION

The ability to obtain real-time transport information is limited mainly to non-interactive display devices at fixed locations e.g., electronic display systems at train and bus stations, or along the roadside for motor transport. Another option available is to passively listen for radio broadcasts that are not likely to be particularly relevant to the transport user's circumstance, or specific enough to be of significant utility. It is also technically feasible for transport operators of a tunnel to override the radio spectrum to broadcast to those within the tunnel, but once again this would only be truly useful for emergency purposes i.e., there would be very little value in informing users that traffic was heavy when they were already in the tunnel and could take no action to avoid it.

The possibility for a user of real-time transport information to initiate a request for transport data, specific to their situation at a time and location convenient to them, has faced a few obstacles that forces them to rely on the previously described information sources. While advanced 3G (third generation) mobile devices exist that could facilitate access to this information, the limited number of telecommunication networks that provide this functionality and the low adoption of these devices by the general public means this is not a valid information provision alternative. Consequently, the primary device available through which to distribute the required information is the highly pervasive second generation mobile phone.

Use of such devices though comes with its own limitations, primarily the lack of a truly interactive data functionality that would allow users to make their transport queries in real-time on an ad-hoc basis. Instead, the user is required to independently construct their own query for the information they are interested in by using, for example the Short Message Service (“SMS”) available on these devices. This requires a large degree of user effort.

### SUMMARY OF THE INVENTION

In accordance with a first aspect of the present invention, there is provided a method of tracking travel plans, the method comprising the steps of: (a) forming a current travel plan on an internet interactive database; (b) initially forwarding a coded indicator of the current travel plan on a mobile communications device; (c) utilising the coded indicator to interrogate a remote database of current travel information to determine travel logistic information relevant to the current travel plan; (d) communicating issues associated with the logistics of the current travel plan with the mobile communications device; (e) conveying the issues to a user of the mobile communications device.

The forwarding can comprise sending an SMS message with the coded indicator to the mobile communications device. The SMS message preferably can include a return address for interrogating the remote database. The step (a) preferably can also include interacting with travel route planning software utilising an internet browser. The remote database can be further interconnected with externally provided transport information databases for real time updates of transport information.

### BRIEF DESCRIPTION OF THE DRAWINGS

Preferred forms of the present invention will now be described with reference to the accompanying drawings in which:

FIG. 1 illustrates schematically the operational environment of the preferred embodiment; and

FIG. 2 illustrates a flow chart of the steps involved in executing the preferred embodiment.

### DESCRIPTION OF PREFERRED AND OTHER EMBODIMENTS

There is a need for the burden of constructing the SMS query to be shifted from the user to the information provider; where artificial means can be used to more efficiently compose the SMS query, as well as there being a comprehensive knowledge base from which to configure a full suite of queries.

Responsibility for the SMS query construction is passed to the information provider via a Web site that allows the user to access a standalone artificially intelligent route planning system with a set of graphical interface tools. Through the selection of a range of options offered to the user and the results of the route planning system, the user's desired query is determined and presented to them in an easily comprehendible form at the information provider's Web site. The query is then converted into SMS format and sent to a mobile device with the number as specified by the user. This mobile device can be a GSM (Global System for Mobile communications) or other mobile device that is capable of accepting a SMS message.

The user is then able to retain the SMS query in their mobile device and reuse this query as often as they chose to at any point in time in the future. When the real— time information related to the query is required, the user will send the SMS query to the information provider's service number, and on receipt of the SMS query the information provider will process it. This procedure is carried out through the information provider's system incorporating real-time third-party information from the relevant transport operators. Once the result of the query has been determined, the information is put into SMS format and returned to the user's mobile device from which the SMS query was sent.

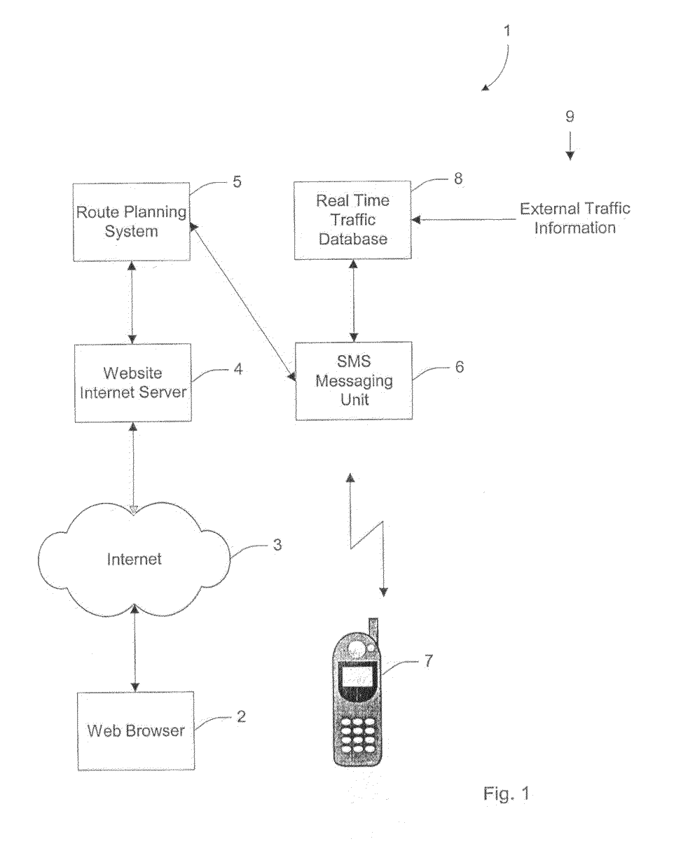

FIG. 1 illustrates schematically the arrangement of the preferred embodiment 1 wherein a user interacts with a web browser 2 over the Internet 3 which is connected to a web site Internet server 4. The Internet server 4 provides account detail information etc. and the user interacts with a route planning system 5 which provides for route planning details. Upon completion of a route, the planning system formulates an appropriate SMS message which is forwarded to an SMS messaging unit 6 which sends the message to the designated handheld mobile phone or the like 7. At a future time, the handheld device 7 is utilised to send the SMS message to SMS messaging unit 6 which interrogates a real time traffic database 8 for providing current traffic information. The database 8 can derive information in real time from various other external suppliers 9.

The process therefore begins with the user employing an internet browser 2 to access the information provider's Web site 4. The option to register with the information provider and create a unique identification profile can be taken up by the user, however this is not an essential element for the service's basic functionality to operate. The primary function is to aid the user in defining the parameters that form the specific query that they have an interest in.

In order to facilitate the specification of these parameters, the Web site enables access to a standalone route planning system 5. This routing system employs a set of algorithms and allows it to determine the best routes for a user according to criteria that they supply. These criteria can be limited to departure and/or arrival points, or extend to include time-related rules e.g., arrive by a specific time, or next departure. Further options can be added to the user's criterion that can come either in the form of a boolean value or preference for a certain outcome measured by a value on a sliding scale e.g., lowest fare or toll cost, limited number of distinct legs in a journey, or preference of waiting time relative to distance required to walk, mode of transport.

The opportunity to select these options are made available to the user through the Web site 4, along with additional graphical interface tools that aid the user's interaction with the information provider's routing system. This includes maps and the ability for the user to focus on a particular area of interest to them e.g., a suburb.

Once the user has specified the criterion to their satisfaction they can submit this to the route planning system, which in return determines the optimum routes in ranked order according to the supplied criterion and presents these results to the user. At this point the user can either further refine the criterion to be resubmitted to the system or accept one of the routing options presented to them. Alternatively the user can select a particular route and manually alter its details to meet their approval.

Once this step in the process is complete, whether through one or multiple iterations of the procedure described above, the final route that results will have a set of relevant queries that can be derived from it. For example in a route that is composed of two distinct legs, the user may be interested in queries on the next departure time from the start of either or both legs e.g., a bus ride to the nearest train station and then catching the train to the final destination. The complete set of these queries is made available to the user, from which they can select one or more of the queries via interaction with the Internet server 4.

Additional options can also be attached at this point to further refine the query e.g., monitor entire route for traffic trouble spots such as traffic jams or reported accidents.

Now the user is able to select the query or queries to be converted and have them sent via SMS messaging unit 6 to their nominated mobile device 7 by the information provider. Each query can be coded into SMS format according to the information provider's protocol such that these will be able to be interpreted correctly at a later point when the user returns the SMS query as an information request. If the user has registered with a profile that contains a number for the mobile device 7, that will be used as the destination for the SMS query, otherwise the user will be prompted for this number. Each SMS query desired by the user will then be sent to this mobile device 7.

If a registered profile for the user exists with the information provider it is also possible to store these queries under that profile along with the route associated with them for added convenience to the user.

From this point the user now has a correctly composed SMS query that they can use latter at their convenience. This SMS query or queries can be stored on their mobile device 7 and reused as often as the user requires. In order to put the query into use, the user retrieves the stored SMS query and sends it to the information provider to SMS message unit 6 through their service number. The information provider uses the received SMS query to retrieve the requested information from the Real Time traffic database 8 that maintains real-time information supplied by a range of transport operators, 9 e.g., public transport organisations, the roads authority, private operators of toll roads. Having determined an appropriate reply to the SMS query, the result can be formatted by SMS message unit 6 and be returned to the user's mobile device 7 via a SMS message from the information provider, satisfying the user's requirement for real-time transport information.

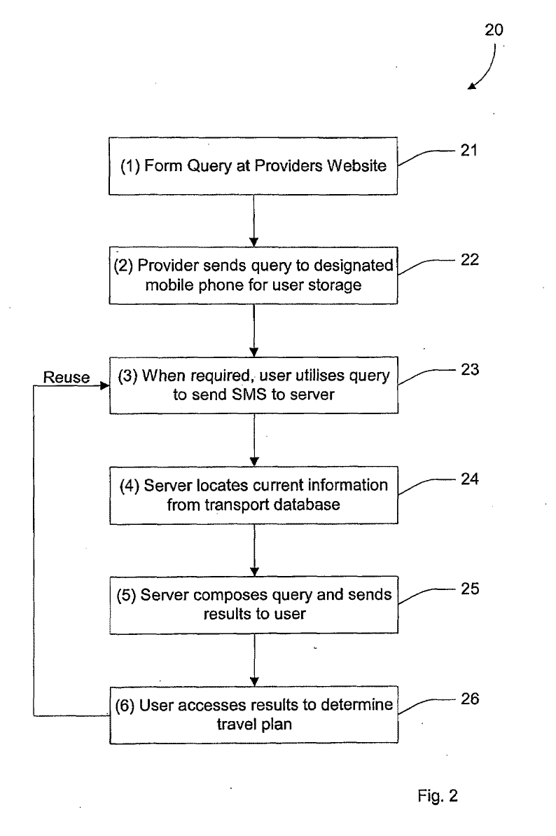

The steps involved in the preferred embodiment can be as illustrated in FIG. 2 wherein the steps 20 first involves a user forming a query at the provider's website 21. The provider sends the query to the designated mobile phone for user storage 22. When it is desired to utilise the query, the user sends the SMS to a server 23. The server locates current information from the transport database 24 and composes and sends the results to the user 25 in an intelligible format. The user then accesses the results to determine their travel plan 26.

The foregoing describes preferred forms of the present invention. Modifications, obvious to those skilled in the art can be made thereto without departing from the scope of the invention.

1. A method of tracking travel plans, the method comprising the steps of:
(a) forming a current travel plan on an internet interactive database;
(b) initially forwarding a coded indicator of the current travel plan on a mobile communications device;
(c) utilizing said coded indicator to interrogate a remote database of current travel information to determine travel logistic information relevant to said current travel plan;
(d) communicating issues associated with the logistics of said current travel plan with said mobile communications device;
(e) conveying said issues to a user of said mobile communications device.

2. A method as claimed in claim 1 wherein said forwarding comprises sending an SMS message with the coded indicator to said mobile communications device.

3. A method as claimed in claim 1 wherein said SMS message includes a return address for interrogating said remote database.

4. A method as claimed in claim 1 wherein said step (a) includes interacting with travel route planning software utilizing an internet browser.

5. A method as claimed in claim 1 wherein said remote database is further interconnected with externally provided transport information databases for real time updates of transport information.

6. A system for formulating and modelling travel plans, the system including:
first interactive system for creating coded indicators of travel plans;
a mobile communications device for receipt of said coded indicator;
real time monitoring system for later receipt of said coded indicator from said mobile communications device, said monitoring system interrogating a current database to determine if any information relevant to a corresponding travel plan to said coded indicator exists and forwarding said information to said mobile communications device for review by a user.

7-8. (canceled)
